(19) United States
(12) Patent Application Publication
(10) Pub. No.: US 2022/0143823 A1
(43) Pub. Date: May 12, 2022

(54) Learning System And Learning Method For Operation Inference Learning Model For Controlling Automatic Driving Robot

(71) Applicant: Meidensha Corporation, Tokyo (JP)

(72) Inventors: Kento Yoshida, Tokyo (JP); Hironobu Fukai, Tokyo (JP); Rinpei Mochizuki, Tokyo (JP)

(73) Assignee: Meidensha Corporation, Tokyo (JP)

(21) Appl. No.: 17/438,168

(22) PCT Filed: Dec. 25, 2019
(86) PCT No.: PCT/JP2019/050747

§ 371 Date: Sep. 10, 2021

(30) Foreign Application Priority Data
Mar. 13, 2019 (JP) 2019-045848

(51) Int. Cl. B25J 9/16; G05B 13/02

(52) U.S. Cl. CPC B25J 9/163; G05B 13/027

(57) ABSTRACT

Provided is a learning system 10 for an operation inference learning model 70 for controlling an automatic driving robot 4, the learning system 10 training the operation inference learning model 70 by reinforcement learning, and comprising the operation inference learning model 70, which infers operations of a vehicle 2 for making the vehicle 2 run in accordance with a defined command vehicle speed based on a running state of the vehicle 2 including a vehicle speed, and the automatic driving robot 4, which is installed in the vehicle 2 and which makes the vehicle 2 run based on the operations. In the learning system 10 for an operation inference learning model 70 for controlling an automatic driving robot 4, the operation inference learning model 70 is pre-trained by reinforcement learning by applying the simulated running state output by the vehicle learning model 60 to the operation inference learning model 70, and after the pre-training by reinforcement learning has ended, the operation inference learning model 70 is further trained by reinforcement learning by applying, to the operation inference learning model 70, the running state acquired by the vehicle 2 being run based on the operations inferred by the operation inference learning model 70.

### TECHNICAL FIELD

The present invention relates to a learning system and a learning method for an operation inference learning model for controlling an automatic driving robot.

### BACKGROUND

Generally, when manufacturing and selling a vehicle such as a standard-sized automobile, the fuel economy and exhaust gases when the vehicle is run in a specific running pattern (mode), defined by the country or by the region, must be measured and displayed.

The mode may be represented, for example, by a graph of the relationship between the time elapsed since the vehicle started running and the vehicle speed to be reached at that time. This vehicle speed to be reached is sometimes referred to as a command vehicle speed in that it represents a command to the vehicle regarding the speed to be reached.

Tests regarding the fuel economy and exhaust gases as mentioned above are performed by mounting the vehicle on a chassis dynamometer and having an automatic driving robot, i.e., a so-called drive robot (registered trademark), which is installed in the vehicle, drive the vehicle in accordance with the mode.

A tolerable error range is defined for the command vehicle speed. If the vehicle speed deviates from the tolerable error range, the test becomes invalid. Thus, high conformity to the command vehicle speed is sought in control by automatic driving robots. For this reason, automatic driving robots are sometimes controlled, for example, by using learning models that have been trained by reinforcement learning.

For example, Patent Document 1 discloses a vehicle running simulation apparatus, a driver model construction method, and a driver model construction program that can construct a driver model for performing human-like pedal operations by reinforcement learning.

More specifically, the vehicle running simulation apparatus automatically sets the gain in the driver model by running the vehicle model multiple times while changing gain values in the driver model, and evaluating the gain values that were changed at these times on the basis of a reward value. The above-mentioned gain value is evaluated not only by a vehicle speed reward function for evaluating vehicle speed conformity, but also by an accelerator reward function for evaluating the smoothness of accelerator pedal operation, and a brake reward function for evaluating the smoothness of brake pedal operation.

The vehicle model used in Patent Document 1, etc. is normally prepared as a physical model by preparing physical models simulating the actions of each constituent element of the vehicle, and combining these physical models.

### CITATION LIST

### Patent Literature

Patent Document 1: JP 2014-115168 A

### SUMMARY OF INVENTION

### Technical Problem

In an apparatus such as that disclosed in Patent Document 1, an operation inference learning model for inferring vehicle operations is trained on the basis of a vehicle model. For this reason, if the reproduction accuracy of the vehicle model is low, then no matter how precisely the operation inference learning model is trained, the operations inferred by the operation inference learning model may not match those in an actual vehicle. In particular, the preparation of a physical model requires fine parameters of actual vehicles to be analyzed and reflected. Thus, it is not easy to construct a highly accurate vehicle model by using such parameters. For this reason, particularly when a physical model is used as a vehicle model, it is difficult to raise the accuracy of operations output by the operation inference learning model.

Meanwhile, the use of an actual vehicle instead of a vehicle model when training an operation inference learning model by reinforcement learning might be contemplated. Specifically, reinforcement learning can be implemented in an operation inference learning model by repeating a process of inferring operations by means of an operation inference learning model, operating an actual vehicle by performing said operations, accumulating running states of the actual vehicle as running histories that are the results of the operations, and further using the accumulated running states to train the operation inference learning model until the accuracy of the operation inferences made by the operation inference learning model increases. In this case, the finally generated operation inference learning model can be made accurate enough to be applicable to actual vehicle testing.

However, in reinforcement learning, the training of a learning model progresses by repeatedly training the learning model and acquiring the running states that are the result of using the operations inferred by the learning model during the training, as described above. Therefore, in the initial stages of training, there is a possibility that the learning model will output undesirable operations that would be impossible for a human and that will stress an actual vehicle such as, for example, operating a pedal with an extremely high frequency.

A problem to be solved by the present invention is to provide a learning system and a learning method for an operation inference learning model for controlling an automatic driving robot (drive robot) that can reduce stress on an actual vehicle by reducing undesirable vehicle operation outputs by the operation inference learning model during reinforcement learning, and that can improve the accuracy of operations output by the operation inference learning model.

### Solution to Problem

In order to solve the above-mentioned problems, the present invention employs the means indicated below. That is, the present invention provides a learning system for an operation inference learning model for controlling an automatic driving robot, the learning system training the operation inference learning model by reinforcement learning, and comprising the operation inference learning model, which infers operations of a vehicle for making the vehicle run in accordance with a defined command vehicle speed based on a running state of the vehicle including a vehicle speed, and the automatic driving robot, which is installed in the vehicle and which makes the vehicle run based on the operations, wherein the learning system comprises a vehicle learning model that has been trained by machine learning to simulate actions of the vehicle based on an actual running history of the vehicle, and that outputs a simulated running state, which is the running state simulating the vehicle based on the operations inferred by the operation inference learning model; and the operation inference learning model is pre-trained by reinforcement learning by applying the simulated running state output by the vehicle learning model to the operation inference learning model, and after the pre-training by reinforcement learning has ended, the operation inference learning model is further trained by reinforcement learning by applying, to the operation inference learning model, the running state acquired by the vehicle being run based on the operations inferred by the operation inference learning model.

Additionally, the present invention provides a learning method for an operation inference learning model for controlling an automatic driving robot, the learning method involving training the operation inference learning model by reinforcement learning in association with the operation inference learning model, which infers operations of a vehicle for making the vehicle run in accordance with a defined command vehicle speed based on a running state of the vehicle including a vehicle speed, and the automatic driving robot, which is installed in the vehicle and which makes the vehicle run based on the operations, wherein the learning method involves pre-training the operation inference learning model by reinforcement learning by outputting a simulated running state, which is the running state simulating the vehicle based on the operations inferred by the operation inference learning model, using a vehicle learning model, which has been trained by machine learning to simulate actions of the vehicle based on an actual running history of the vehicle, and by applying the simulated running state to the operation inference learning model, and after the pre-training by reinforcement learning has ended, further training the operation inference learning model by reinforcement learning by applying, to the operation inference learning model, the running state acquired by the vehicle being run based on the operations inferred by the operation inference learning model.

### Effects of Invention

The present invention can provide a learning system and a learning method for an operation inference learning model for controlling an automatic driving robot (drive robot) that can reduce stress on an actual vehicle by reducing undesirable vehicle operation outputs by the operation inference learning model during reinforcement learning, and that can improve the accuracy of operations output by the operation inference learning model.

### BRIEF DESCRIPTION OF DRAWINGS

FIG. 1 is an explanatory diagram of a testing environment using an automatic driving robot (drive robot) in an embodiment of the present invention.

FIG. 2 is a block diagram describing the processing flow when training a vehicle learning model in a learning system for an operation inference learning model for controlling the automatic driving robot in the above-described embodiment.

FIG. 3 is a block diagram of the above-mentioned vehicle learning model.

FIG. 4 is a block diagram describing the processing flow when pre-training the operation inference learning model in the learning system for the operation inference learning model for controlling the above-mentioned automatic driving robot.

FIG. 5 is a block diagram of the above-mentioned operation inference learning model.

FIG. 6 is a block diagram of a value inference learning model used to train the above-mentioned operation inference learning model by reinforcement learning.

FIG. 7 is a block diagram describing the processing flow when training the operation inference learning model by reinforcement learning after pre-training has ended in the learning system for the operation inference learning model for controlling the above-mentioned automatic driving robot.

FIG. 8 is a flow chart of a learning method for the operation inference learning model for controlling the automatic driving robot in the above-described embodiment.

### DESCRIPTION OF EMBODIMENTS

Hereinafter, an embodiment of the present embodiment will be explained in detail by referring to the drawings.

In the present embodiment, a drive robot (registered trademark) is used as the automatic driving robot. Therefore, hereinafter, the automatic driving robot will be referred to as a drive robot.

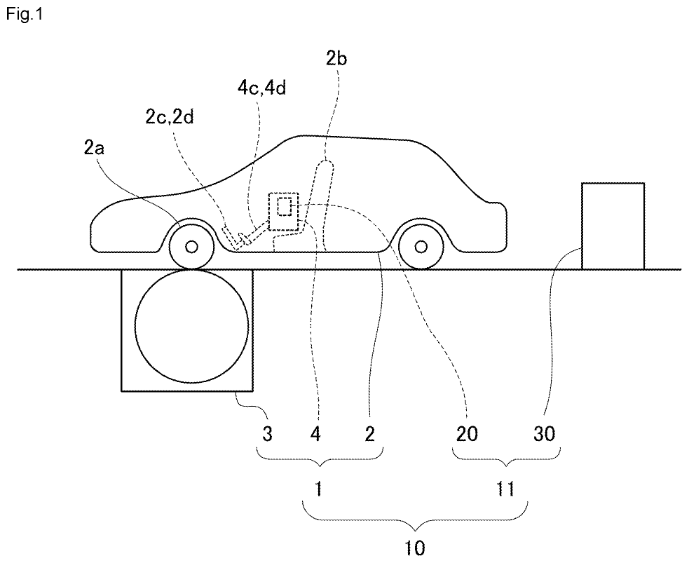

FIG. 1 is an explanatory diagram of a testing environment using a drive robot in the embodiment. A testing apparatus 1 is provided with a vehicle 2, a chassis dynamometer 3, and a drive robot 4.

The vehicle 2 is provided on a floor surface. The chassis dynamometer 3 is provided below the floor surface. The vehicle 2 is positioned so that a drive wheel 2a of the vehicle 2 is mounted on the chassis dynamometer 3. When the vehicle 2 runs and the drive wheel 2a rotates, the chassis dynamometer 3 rotates in the opposite direction.

The drive robot 4 is installed on a driver's seat 2b in the vehicle 2 and makes the vehicle 2 run. The drive robot 4 is provided with a first actuator 4c and a second actuator 4d, which are respectively provided so as to be in contact with an accelerator pedal 2c and a brake pedal 2d in the vehicle 2.

The drive robot 4 is controlled by a learning control apparatus 11, which will be described in detail below. The learning control apparatus 11 changes and adjusts the depression levels of the accelerator pedal 2c and the brake pedal 2d of the vehicle 2 by controlling the first actuator 4c and the second actuator 4d of the drive robot 4.

The learning control apparatus 11 controls the drive robot 4 so that the vehicle 2 runs in accordance with defined command vehicle speeds. That is, the learning control apparatus 11 controls the running of the vehicle 2 in accordance with a defined running pattern (mode) by changing the depression levels of the accelerator pedal 2c and the brake pedal 2d in the vehicle 2. More specifically, the learning control apparatus 11 controls the running of the vehicle 2 so as to follow the command vehicle speeds that are vehicle speeds to be reached at different times as time elapses after the vehicle starts running.

The learning control system (learning system) 10 is provided with the testing apparatus 1 and the learning control apparatus 11 as described above.

The learning control apparatus 11 is provided with a drive robot control unit 20 and a learning unit 30.

The drive robot control unit 20 controls the drive robot 4 by generating a control signal for controlling the drive robot 4 and transmitting the control signal to the drive robot 4. The learning unit 30 implements machine learning as explained below and generates a vehicle learning model, an operation inference learning model, and a value inference learning model. A control signal for controlling the drive robot 4, as described above, is generated by the operation inference learning model.

The drive robot control unit 20 is, for example, an information processing apparatus such as a controller provided on the exterior of the housing of the drive robot 4. The learning unit 30 is, for example, an information processing apparatus such as a personal computer.

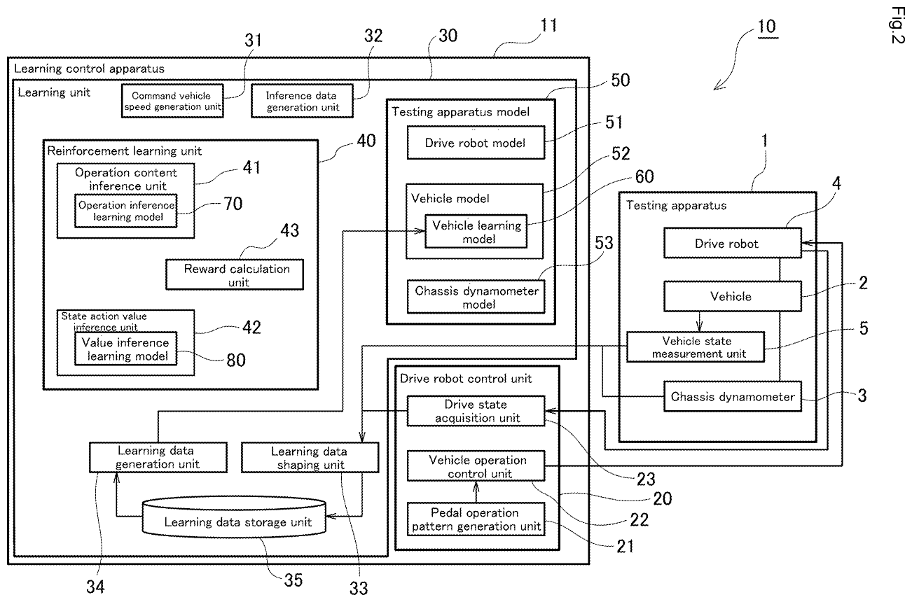

FIG. 2 is a block diagram of the learning control system 10. In FIG. 2, the lines connecting the constituent elements only indicate the exchange of data that occurs when training the above-mentioned vehicle learning model by machine learning. Therefore, they do not indicate the exchange of all data between the constituent elements.

The testing apparatus 1 is provided with a vehicle state measurement unit 5 in addition to the vehicle 2, the chassis dynamometer 3, and the drive robot 4 that have already been explained. The vehicle state measurement unit 5 comprises various types of measurement apparatuses for measuring the state of the vehicle 2. The vehicle state measurement unit 5 may, for example, be a camera, an infrared sensor, or the like for measuring the operation level of the accelerator pedal 2c or the brake pedal 2d.

In the present embodiment, the drive robot 4 operates the pedals 2c, 2d by controlling the first and second actuators 4c, 4d. Therefore, even without depending on the vehicle state measurement unit 5, the operation levels of the pedals 2c, 2d can be determined, for example, based on the control levels or the like of the first and second actuators 4c, 4d. For this reason, the vehicle state measurement unit 5 is not an essential feature in the present embodiment. However, the vehicle state measurement unit 5 becomes necessary, for example, in the case that the operation levels of the pedals 2c, 2d are to be determined when a person is driving the vehicle 2 instead of the drive robot 4, and in the case that the state of the vehicle 2, such as the engine rotation speed, the gear state, the engine temperature, and the like are to be determined by being directly measured, as will be described as modified examples below.

The drive robot control unit 20 is provided with a pedal operation pattern generation unit 21, a vehicle operation control unit 22, and a drive state acquisition unit 23. The learning unit 30 is provided with a command vehicle speed generation unit 31, an inference data shaping unit 32, a learning data shaping unit 33, a learning data generation unit 34, a learning data storage unit 35, a reinforcement learning unit 40, and a testing apparatus model 50. The reinforcement learning unit 40 is provided with an operation content inference unit 41, a state action value inference unit 42, and a reward calculation unit 43. The testing apparatus model 50 is provided with a drive robot model 51, a vehicle model 52, and a chassis dynamometer model 53.

The constituent elements of the learning control apparatus 11 other than the learning data storage unit 35 may, for example, be software or programs executed by a CPU in each of the above-mentioned information processing apparatuses. Additionally, the learning data storage unit 35 may be realized by a storage apparatus, such as a semiconductor memory unit or a magnetic disk, provided inside or outside each of the above-mentioned information processing apparatuses.

As will be explained below, the operation content inference unit 41, based on a running state at a certain time, infers the operations of the vehicle 2 after said time such that the command vehicle speeds will be followed. In order to effectively perform these inferences of the operations of the vehicle 2, the operation content inference unit 41, in particular, is provided with a machine learning device as will be explained below, and generates a learning model (operation inference learning model) 70 by training the machine learning device by reinforcement learning based on rewards calculated on the basis of running states at times after the drive robot 4 has been operated based on inferred operations. When actually controlling the running of the vehicle 2 for performance measurements, the operation content inference unit 41 uses this operation inference learning model 70 in which the training has ended to infer the operations of the vehicle 2.

That is, the learning control system 10 largely performs two types of actions, namely, the learning of operations during reinforcement learning, and the inference of operations when controlling the running of the vehicle for performance measurements. To simplify the explanation, hereinafter, an explanation of the respective constituent elements in the learning control system 10 at the time of learning the operations will be followed by an explanation of the activity of the respective constituent elements when inferring the operations during vehicle performance measurements.

First, the activity of the constituent elements of the learning control apparatus 11 when learning the operations will be explained.

Before learning the operations, the learning control apparatus 11 collects, as a running history, running history data (running history) to be used during the learning. Specifically, the drive robot control unit 20 generates operation patterns of the accelerator pedal 2c and the brake pedal 2d for measuring vehicle characteristics, controls the running of the vehicle by means of these operation patterns, and collects running history data.

The pedal operation pattern generation unit 21 generates operation patterns of the pedals 2c, 2d for measuring vehicle characteristics. As the pedal operation patterns, for example, pedal operation history values used when running another vehicle similar to the vehicle 2 in a WLTC (Worldwide harmonized Light vehicles Test Cycle) mode or the like may be used.

The pedal operation pattern generation unit 21 transmits the generated pedal operation patterns to the vehicle operation control unit 22.

The vehicle operation control unit 22 receives the pedal operation patterns from the pedal operation pattern generation unit 21, converts the pedal operation patterns to commands for the first and second actuators 4c, 4d in the drive robot 4, and transmits the commands to the drive robot 4.

Upon receiving the commands for the actuators 4c, 4d, the drive robot 4 makes the vehicle 2 run on the chassis dynamometer 3 on the basis thereof.

The drive state acquisition unit 23 acquires actual drive states of the drive robot 4, such as, for example, the positions of the actuators 4c, 4d. The running states of the vehicle 2 sequentially change due to the vehicle 2 running. The running states of the vehicle 2 are measured by various measuring devices provided in the drive state acquisition unit 23, the vehicle state measurement unit 5, and the chassis dynamometer 3. For example, as mentioned above, the drive state acquisition unit 23 measures a detection level of the accelerator pedal 2c and a detection level of the brake pedal 2d as running states. Additionally, a measuring device provided in the chassis dynamometer 3 measures the vehicle speed as a running state.

The measured running states of the vehicle 2 are transmitted to the learning data shaping unit 33 in the learning unit 30.

The learning data shaping unit 33 receives the running states of the vehicle 2, converts the received data to formats used later in various types of learning, and stores the data as running history data in the learning data storage unit 35.

When the collection of the running states, i.e., the running history data, of the vehicle 2 ends, the learning data generation unit 34 acquires running history data from the learning data storage unit 35, shapes the data in an appropriate format, and transmits the data to the testing apparatus model 50.

The vehicle model 52 in the testing apparatus model 50 acquires the shaped running history data from the learning data generation unit 34 and uses the data to train the machine learning device 60 by machine learning to generate a vehicle learning model 60. The vehicle learning model 60 has been trained by machine learning to simulate the actions of the vehicle 2 based on the running history data, which represents the actual running history of the vehicle 2, and upon receiving operations on the vehicle 2, the vehicle learning model 60 outputs simulated running states, which are running states simulating the vehicle 2, on the basis thereof. That is, the machine learning device 60 in the vehicle model 52 generates a learned model 60 that has been obtained by learning appropriate learning parameters and that is to be used as a program module constituting a portion of artificial intelligence software.

In the present embodiment, the vehicle learning model 60 is realized by a neural network, and machine learning is implemented by inputting, as learning data, a running state having a prescribed time as a reference point, by inputting, as teacher data, a running history for a time later than the prescribed time, by outputting a simulated running state for the later time, and by comparing the simulated running state with the teacher data.

Hereinafter, in order to simplify the explanation, both the machine learning device provided in the vehicle model 52 and the learning model generated by training the machine learning device will be referred to as the vehicle learning model 60.

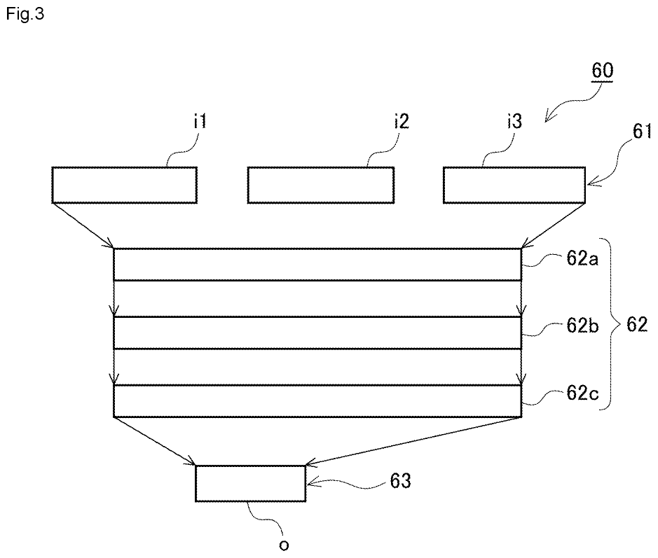

FIG. 3 is a block diagram of the vehicle learning model 60. In the present embodiment, the vehicle learning model 60 is realized by a fully connected neural network having a total of five layers, with three layers as intermediate layers. The vehicle learning model 60 is provided with an input layer 61, intermediate layers 62, and an output layer 63. In FIG. 3, each layer is drawn as a rectangle, and the nodes included in each layer are omitted.

In the present embodiment, the running states that are input to the vehicle learning model 60 include a series of vehicle speeds from a time that is a prescribed first time period in the past to a time serving as a reference point, the reference point being an arbitrary prescribed time. Additionally, in the present embodiment, the running states that are input to the vehicle learning model 60 include a series of operation levels of the accelerator pedal 2c and a series of operation levels of the brake pedal 2d from the time serving as the reference point to a time that is a prescribed second time period in the future.

The input layer 61 is provided with input nodes corresponding to each of a vehicle speed series i1, which is a vehicle speed series as mentioned above, an accelerator pedal series i2, which is a series of operation levels of the accelerator pedal 2c, and a brake pedal series i3, which is a series of operation levels of the brake pedal 2d.

As mentioned above, the inputs i1, i2, and i3 are series, each being realized by multiple values. For example, the input corresponding to the vehicle speed series i1, which is shown as a single rectangle in FIG. 3, is actually provided with input nodes corresponding to each of the multiple values in the vehicle speed series i1.

The vehicle model 52 stores the values of corresponding running history data in each input node.

The intermediate layers 62 include a first intermediate layer 62a, a second intermediate layer 62b, and a third intermediate layer 62c.

In each node in the intermediate layers 62, from the nodes in the preceding layer (for example, the input layer 61 in the case of the first intermediate layer 62a, and the first intermediate layer 62a in the case of the second intermediate layer 62b), calculations are performed on the basis of the values stored in the nodes in the preceding layer and weights from the nodes in the preceding layer to the nodes in that intermediate layer 62, and the calculation results are stored in the nodes in that intermediate layer 62.

In the output layer 63 also, calculations similar to those in the intermediate layers 62 are performed, and calculation results are stored in the output nodes provided in the output layer 63.

In the present embodiment, the output of the vehicle learning model 60 is a series of vehicle speeds estimated from the time serving as the reference point to a time that is a prescribed third time period in the future. This estimated vehicle speed series o is a series, and thus is realized by multiple values. For example, the output corresponding to the estimated vehicle speed series o, which is shown as a single rectangle in FIG. 3, is actually provided with output nodes corresponding to each of the multiple values in the estimated vehicle speed series o.

In the vehicle learning model 60, learning is implemented by inputting the running histories at prescribed times as the running states i1, i2, and i3 as mentioned above so as to be able to output appropriate estimated vehicle speed series o of later times as simulated running states o, which are running states simulating the running of the vehicle 2.

More specifically, the vehicle model 52 receives, as teacher data, a running history, i.e., correct values of the vehicle speed series in the present embodiment, from a prescribed time serving as a reference point to a time that is the prescribed third time period in the future, separately transmitted from the learning data storage unit 35 via the learning data generation unit 34. The vehicle model 52 uses the error backpropagation method and the stochastic gradient descent method to adjust the values of the parameters constituting the neural network, such as weight and bias values, so as to reduce the mean-squared error between the teacher data and the estimated vehicle speed series o output by the vehicle learning model 60.

While repeatedly training the vehicle learning model 60, the vehicle model 52 calculates the least-squares error between the teacher data and the estimated vehicle speed series o each time, and when this error becomes smaller than a prescribed value, the training of the vehicle learning model 60 ends.

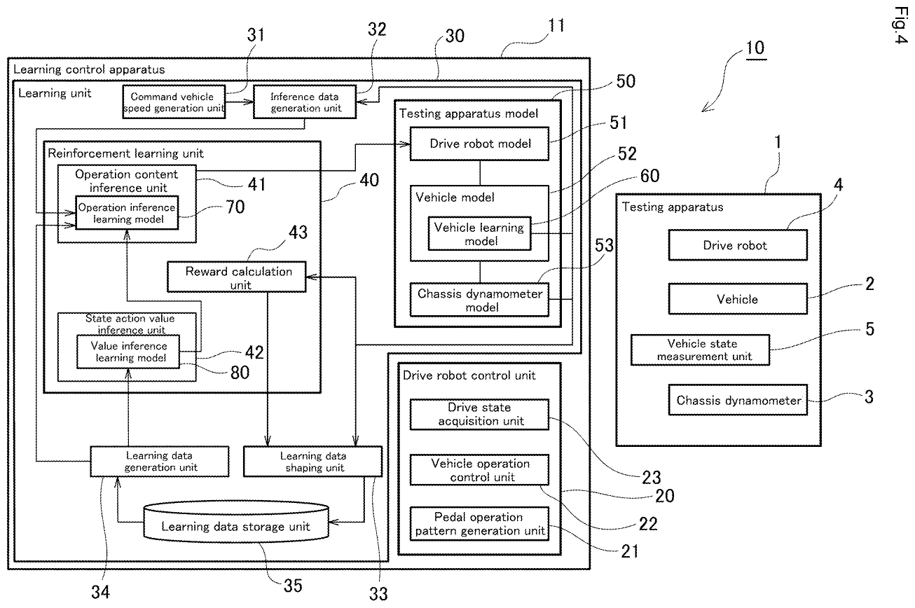

When the training of the vehicle learning model 60 ends, the reinforcement learning unit 40 in the learning control system 10 pre-trains the operation inference learning model 70 provided in the operation content inference unit 41 to infer the operations of the vehicle 2. FIG. 4 is a block diagram of the learning control system 10 indicating the data exchange relationship during the pre-training. Due to the training of the machine learning device, the operation inference learning model 70 becomes a learned model that has learned appropriate learning parameters and that is to be used as a program module constituting a portion of artificial intelligence software.

The learning control system 10 pre-trains the operation inference learning model 70 by reinforcement learning by applying, to the operation inference learning model 70, simulated running states output by the vehicle learning model 60 in which the training has ended. As will be explained below, after the reinforcement learning of the operation inference learning model 70 has progressed and the pre-training by reinforcement learning has ended, the operation inference learning model 70 is further trained by reinforcement learning by applying, to the operation inference learning model 70, running states acquired by actually running the vehicle 2 based on operations output by the operation inference learning model 70. Thus, the learning control system 10 changes the subject that is to perform the inferred operations and from which the running states are to be acquired from the vehicle learning model 60 to the actual vehicle 2 in accordance with the learning stage of the operation inference learning model 70.

As explained below, the operation content inference unit 41 outputs operations of the vehicle 2 from the current time to a time that is the prescribed third time period in the future, and transmits these operations to the drive robot model 51. In the present embodiment, the operation content inference unit 41 particularly outputs series of operations of the accelerator pedal 2c and the brake pedal 2d.

Due to the training of the vehicle learning model 60, the testing apparatus model 50 is configured to simulate the actions of each testing apparatus 1 overall. The testing apparatus model 50 receives the series of operations.

The drive robot model 51 is configured to simulate the actions of the drive robot 4. The drive robot model 51, based on the received operations, generates the accelerator pedal series i2 and the brake pedal series i3 that are to be input to the vehicle learning model 60 in which the training has ended, and transmits the series to the vehicle model 52.

The chassis dynamometer 53 is configured to simulate the actions of the chassis dynamometer 3. The chassis dynamometer 3, while detecting the vehicle speeds of the vehicle learning model 60 during simulated running, periodically records these vehicle speeds in the interior thereof. The chassis dynamometer model 53 generates a vehicle speed series i1 from the past vehicle speed records and transmits the series to the vehicle model 52.

The vehicle model 52 receives the vehicle speed series i1, the accelerator pedal series i2, and the brake pedal series i3, and inputs these series to the vehicle learning model 60. When the vehicle learning model 60 outputs the estimated vehicle speed series o, the vehicle model 52 transmits the estimated vehicle speed series o to the estimated data shaping unit 32.

The chassis dynamometer model 53 detects the vehicle speeds at this time from the vehicle learning model 60, updates the vehicle speed series i1, and transmits the series to the inference data shaping unit 32.

The command vehicle speed generation unit 31 holds command vehicle speeds generated on the basis of information regarding the mode. The command vehicle speed generation unit 31 generates a series of command vehicle speeds to be followed by the vehicle learning model 60 from the current time to a time that is a prescribed fourth time period in the future, and transmits the series to the inference data shaping unit 32.

The inference data shaping unit 32 receives the estimated vehicle speed series o and the command vehicle speed series, and after having appropriately shaped them, transmits the series to the reinforcement learning unit 40.

The reinforcement learning unit 40 holds operations of the accelerator pedal 2c and the brake pedal 2d that have been transmitted in the past. The reinforcement learning unit 40 deems these transmitted operations to be detected values resulting from the vehicle learning model 60 actually complying therewith, and based on these series of operations of the accelerator pedal 2c and the brake pedal 2d, generates series of past accelerator pedal detection levels and brake pedal detection levels. The reinforcement learning unit 40 transmits these series, together with the estimated vehicle speed series o and the command vehicle speed series, as running states, to the operation content inference unit 41.

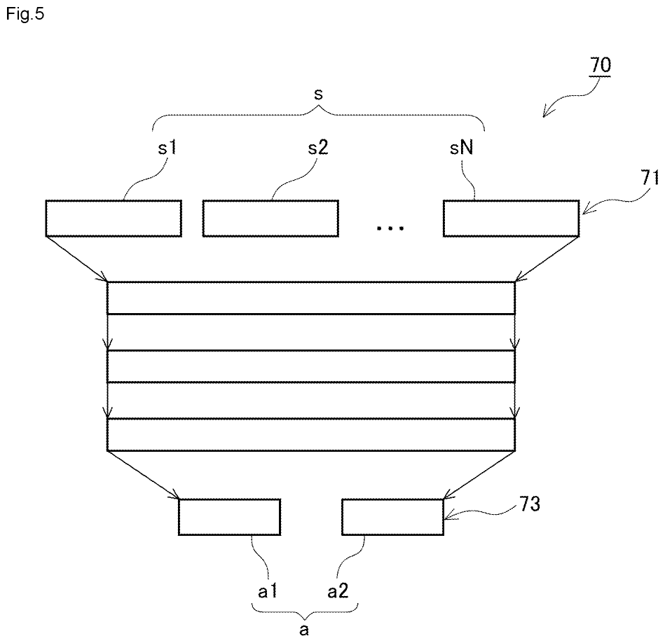

Upon receiving running states at a certain time, the operation content inference unit 41, on the basis thereof, infers a series of operations subsequent to said time by using the operation inference learning model 70 being trained. FIG. 5 is a block diagram of an operation inference learning model 70.

In the input layer 71 of the operation inference learning model 70, input nodes are provided so as to correspond to each of the running states s, for example, from an accelerator pedal detection level s1 and a brake pedal detection level s2 to a command vehicle speed sN. The operation inference learning model 70 is realized by a neural network having a structure similar to that of the vehicle learning model 60. Thus, a detailed structural explanation will be omitted.

In the output layer 73 of the operation inference learning model 70, each output node is provided so as to correspond to each operation a. In the present embodiment, what is to be operated are the accelerator pedal 2c and the brake pedal 2d, and the operations a form, for example, an accelerator pedal operation series a1 and a brake pedal operation series a2.

The operation content inference unit 41 transmits the accelerator pedal operations a1 and the brake pedal operations a2 generated in this way to the drive robot model 51. The drive robot model 51 generates an accelerator pedal series i2 and a brake pedal series i3 on the basis thereof, and transmits these series to the vehicle learning model 60. The vehicle learning model 60 infers the next vehicle speed. The next running states s are generated on the basis of the next vehicle speed.

The training of the operation inference learning model 70, i.e., adjustment of the parameters constituting the neural network by the error backpropagation method and the stochastic gradient descent method, is not performed at the current stage, and the operation inference learning model 70 only infers the operations a. The operation inference learning model 70 is trained afterwards, together with the training of a value inference learning model 80.

The reward calculation unit 43 calculates, by means of an appropriately designed expression, a reward based on the running states s, the operations a inferred by the operation inference learning model 70 in correspondence therewith, and the running states s newly generated on the basis of the operations a. The reward is designed to have a smaller value when the operations a and the running states s newly generated therewith are less desirable, and to have a larger value when the operations a and the running states s are more desirable. The state action value inference unit 42, which will be described below, calculates action values so as to be higher when the reward is larger, and the operation inference learning model 70 is trained by reinforcement learning so as to output operations a that make this action value higher.

The reward calculation unit 43 transmits, to the learning data shaping unit 33, the running states s, the operations a inferred in correspondence therewith, and the running states s newly generated on the basis of the operations a. The learning data shaping unit 33 appropriately shapes the data and saves the data in the learning data storage unit 35. These data are used to train the value inference learning model 80, which will be described below.

In this manner, the inference of operations a by the operation content inference unit 41, the inference of estimated vehicle speed series o by the vehicle model 52 corresponding to the operations a, and the calculation of rewards are repeatedly performed until sufficient data is accumulated for training the value inference learning model 80.

When a sufficient amount of running data has been accumulated in the learning data storage unit 35 for training the value inference learning model 80, the state action value inference unit 42 trains the value inference learning model 80. Due to the training of the machine learning device, the value inference learning model 80 becomes a learned model that has learned appropriate learning parameters and that is to be used as a program module constituting a portion of artificial intelligence software.

The reinforcement learning unit 40, overall, calculates an action value indicating how appropriate the operations a inferred by the operation inference learning model 70 were, and the operation inference learning model 70 is trained by reinforcement learning so as to output operations a that make this action value higher. The action value is represented as a function Q having the running states s and the operations a corresponding thereto as arguments, and is designed so that the action value Q becomes higher as the reward becomes larger. In the present embodiment, this function Q is calculated by the learning model 80, serving as a function approximator, designed to take the running states s and the operations a as inputs, and to output the action value Q.

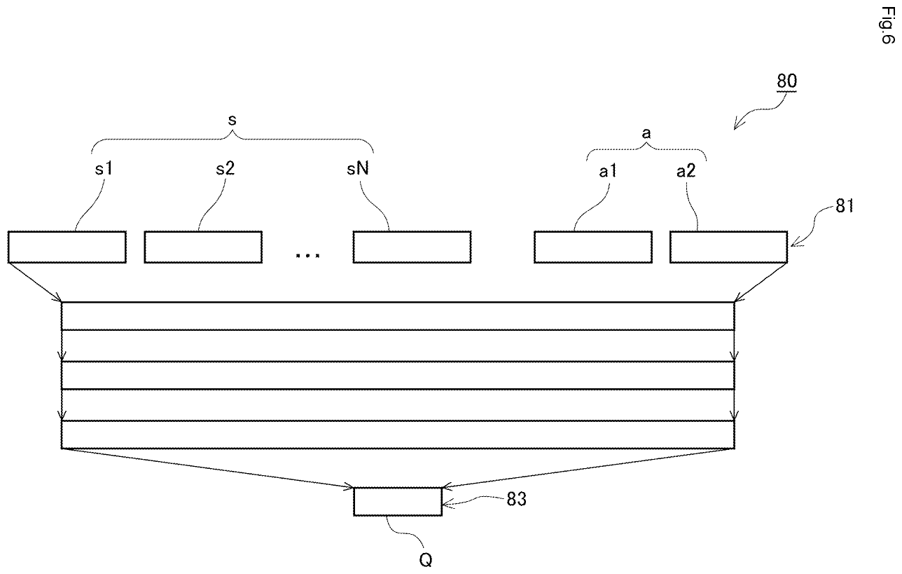

The state action value inference unit 42 receives, from the learning data storage unit 35, the running states s and the operations a shaped by the learning data generation unit 34, and trains the value inference learning model 80 by machine learning. FIG. 6 is a block diagram of the value inference learning model 80.

In the input layer 81 of the value inference learning model 80, input nodes are provided so as to correspond to each of the running states s, for example, from an accelerator pedal detection level s1 and a brake pedal detection level s2 to a command vehicle speed sN, and to each of the operations a, for example, of the accelerator pedal operation a1 and the brake pedal operation a2. The value inference learning model 80 is realized by a neural network having a structure similar to that of the vehicle learning model 60. Thus, a detailed structural explanation will be omitted.

In the output layer 83 of the value inference learning model 80, there is, for example, one output node, which corresponds to the calculated value of the action value Q.

The reward calculation unit 43 uses the error backpropagation method and the stochastic gradient descent method to adjust the values of the parameters constituting the neural network, such as weight and bias values, so as to reduce the TD (Temporal Difference) error, i.e., the error between the action value before performing the operations a and the action value after performing the operations a, so that an appropriate value is output as the action value Q. In this way, the value inference learning model 80 is trained so as to be able to appropriately evaluate the operations a inferred by the current operation inference learning model 70.

When the training of the value inference learning model 80 ends, the value inference learning model 80 outputs a more appropriate value of the action value Q. That is, the value of the action value Q output by the value inference learning model 80 changes from the value before training. Thus, in conjunction therewith, the operation inference learning model 70 that has been designed to output operations a making the action value Q higher must be updated. For this reason, the operation content inference unit 41 trains the operation inference learning model 70.

Specifically, the state action value inference unit 42 trains the operation inference learning model 70, for example, by representing negative values of the action value Q with a loss function, and by using the error backpropagation method and the stochastic gradient descent method to adjust the values of the parameters constituting the neural network, such as weight and bias values, so as to minimize the loss function, i.e., so as to output operations a that make the action value Q larger.

When the operation inference learning model 70 is trained and updated, the output operations a change. Thus, the running data is accumulated again and the value inference learning model 80 is trained on the basis thereof.

By repeatedly training the operation inference learning model 70 and the value inference learning model 80, the learning unit 30 trains these learning models 70, 80 by reinforcement learning.

The learning unit 30 implements reinforcement learning in which the vehicle learning model 60 is used to perform the operations a as pre-training until a prescribed pre-training ending standard is satisfied.

For example, the learning unit 30 performs the pre-training until sufficient running performance is obtained by control in which the vehicle learning model 60 is used to perform the operations a. For example, if the learning control system 10 is intended to be used for mode-based running, then pre-training is implemented until, in mode-based running by the vehicle learning model 60, the error between vehicle speed commands and the estimated vehicle speed series o becomes a sufficiently small value that is no more than a prescribed threshold value.

Alternatively, if the number of times that the accelerator pedal 2c and the brake pedal 2d are operated within a prescribed time range, the operation levels and the rate of change thereof become no more than a prescribed threshold value, it may be determined that, even when tests are performed with an actual vehicle 2, there is a low probability that the vehicle 2 will be largely stressed, thus ending the pre-training.

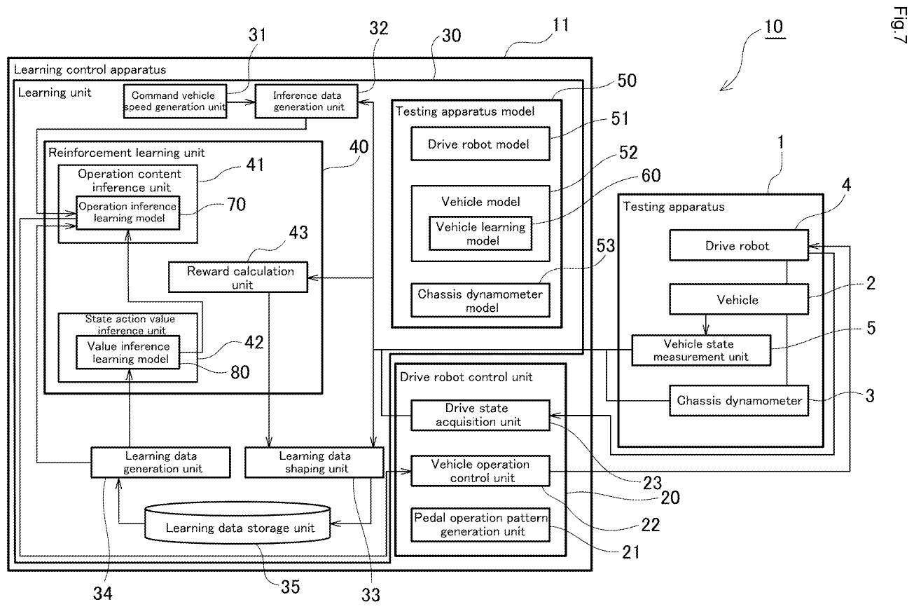

When the pre-training of the operation inference learning model 70 and the value inference learning model 80 in which the vehicle learning model 60 is used to perform the operations a ends, the learning unit 30 further trains the operation inference learning model 70 and the value inference learning model 80 by reinforcement learning by performing the operations a with the actual vehicle 2 instead of the vehicle learning model 60. FIG. 7 is a block diagram of a learning control system 10 indicating the data transmission relationships during reinforcement learning after pre-training has ended.

The operation content inference unit 41 outputs operations a of the vehicle 2 from the current time to a time that is the prescribed third time period in the future, and transmits these operations to the vehicle operation control unit 22.

The vehicle operation control unit 22 converts the received operations a to commands for the first and second actuators 4c, 4d in the drive robot 4, and transmits the commands to the drive robot 4.

Upon receiving the commands for the actuators 4c, 4d, the drive robot 4 makes the vehicle 2 run on the chassis dynamometer 3 on the basis thereof.

The chassis dynamometer 3 detects the vehicle speed of the vehicle 2, generates a vehicle speed series, and transmits the series to the inference data shaping unit 32.

The command vehicle speed generation unit 31 generates a command vehicle speed series and transmits the series to the inference data shaping unit 32.

The inference data shaping unit 32 receives the vehicle speed series and the command vehicle speed series, and after having appropriately shaped them, transmits the series to the reinforcement learning unit 40.

The reinforcement learning unit 40 uses the above-mentioned vehicle speed series instead of the estimated vehicle speed series o generated by the vehicle model 52 to accumulate, in the learning data storage unit 35, learning data in which the actual vehicle 2 is used to perform the operations a, as mentioned above, in a manner similar to the pre-training that was explained using FIG. 4. When a sufficient amount of running data has been accumulated, the reinforcement learning unit 40 trains the value inference learning model 80 and thereafter trains the operation inference learning model 70.

By repeatedly accumulating learning data and training the operation inference learning model 70 and the value inference learning model 80, the learning unit 30 trains these learning models 70, 80 by reinforcement learning.

The learning unit 30 implements reinforcement learning in which the vehicle 2 is used to perform the operations a until a prescribed training ending standard is satisfied.

For example, the learning unit 30 performs pre-training until sufficient running performance is obtained with control using the vehicle 2 to perform the operations a. For example, if the learning control system 10 is intended to be used for mode-based running, then pre-training is implemented until, in mode-based running by the vehicle 2, the error between vehicle speed commands and the vehicle speeds actually detected by the chassis dynamometer 3 becomes a sufficiently small value that is no more than a prescribed threshold value.

Next, the activity of the constituent elements of the learning control system 10 when inferring the operations a during performance measurements of the vehicle 2, i.e., after the training of the operation inference learning model 70 by reinforcement learning has ended, will be explained.

The vehicle speed of the vehicle 2, the detection level of the accelerator pedal 2c, the detection level of the brake pedal 2d, and the like are measured by various measuring devices provided in the drive state acquisition unit 23, the vehicle state measurement unit 5, and the chassis dynamometer 3. These values are transmitted to the inference data shaping unit 32.

The command vehicle speed generation unit 31 generates a command vehicle speed series and transmits the series to the inference data shaping unit 32.

The inference data shaping unit 32 receives the command vehicle speed series and the vehicle speed, the detection level of the accelerator pedal 2c, the detection level of the brake pedal 2d, and the like, and after having appropriately shaped the data, transmits the data to the reinforcement learning unit 40 as running states.

Upon receiving the running states, the operation content inference unit 41, on the basis thereof, infers operations a of the vehicle 2 by means of the learned operation inference learning model 70.

The operation content inference unit 41 transmits the inferred operations a to the vehicle operation control unit 22.

The vehicle operation control unit 22 receives operations a from the operation content inference unit 41 and operates the drive robot 4 based on these operations a.

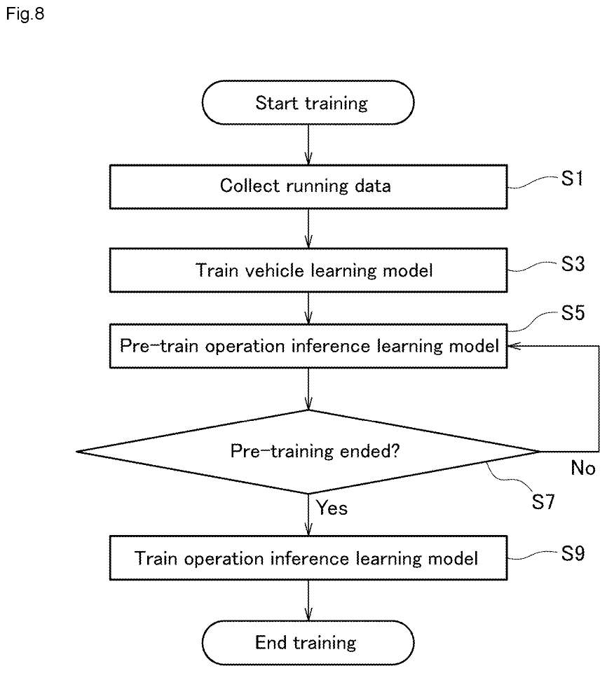

Next, using FIGS. 1-7 and FIG. 8, the learning method for the operation inference learning model 70 for controlling the drive robot 4 using the above-mentioned learning control system 10 will be explained. FIG. 8 is a flow chart of the learning method.

Before learning the operations, the learning control apparatus 11 collects, as running histories, the running history data (running histories) used during training. Specifically, the drive robot control unit 20 generates operation patterns of the accelerator pedal 2c and the brake pedal 2d for use in measuring vehicles characteristics, controls the running of the vehicle 2 thereby, and collects running history data (step S1).

The vehicle model 52 acquires the shaped running history data from the learning data generation unit 34, and uses the data to train the machine learning device 60 by machine learning to generate the vehicle learning model 60 (step S3).

When the training of the vehicle learning model 60 ends, the reinforcement learning unit 40 in the learning control system 10 pre-trains the operation inference learning model 70 for inferring the operations of the vehicle 2 (step S5). More specifically, the learning control system 10 pre-trains the operation inference learning model 70 by reinforcement learning by applying, to the operation inference learning model 70, simulated running states output by the vehicle learning model 60 in which training has already ended.

The learning unit 30 implements this reinforcement learning in which the vehicle learning model 60 is used to perform the operations a, as pre-training, until a prescribed pre-training ending standard is satisfied. The pre-training is continued unless the pre-training ending standard is not satisfied (No in step S7). When the pre-training ending standard is satisfied (Yes in step S7), the pre-training ends.

When the pre-training of the operation inference learning model 70 and the value inference learning model 80 in which the vehicle learning model 60 is used to perform the operations a ends, the learning unit 30 further trains the operation inference learning model 70 and the value inference learning model 80 by reinforcement learning in which the operations a are performed by the actual vehicle 2 instead of the vehicle learning model 60 (step S9).

Next, the effects of the learning system and the learning method for the operation inference learning model for controlling the drive robot described above will be explained.

The learning control system 10 in the present embodiment is a learning system 10 for an operation inference learning model 70 for controlling a drive robot 4, the learning system 10 training the operation inference learning model 70 by reinforcement learning and comprising the operation inference learning model 70, which infers operations a of a vehicle 2 for making the vehicle 2 run in accordance with a defined command vehicle speed based on a running state s of the vehicle 2 including a vehicle speed, and the drive robot (automatic driving robot) 4, which is installed in the vehicle 2 and which makes the vehicle 2 run based on the operations a. A vehicle learning model 60 that has been trained by machine learning to simulate actions of the vehicle 2 based on an actual running history of the vehicle 2, and that outputs a simulated running state o, which is the running state s simulating the vehicle 2 based on the operations a inferred by the operation inference learning model 70, is provided. The operation inference learning model 70 is pre-trained by reinforcement learning by applying the simulated running state o output by the vehicle learning model 60 to the operation inference learning model 70, and after the pre-training by reinforcement learning has ended, the operation inference learning model 70 is further trained by reinforcement learning by applying, to the operation inference learning model 70, the running state s acquired by the vehicle 2 being run based on the operations a inferred by the operation inference learning model 70.

Additionally, the learning control method in the present embodiment is a learning method for an operation inference learning model 70 for controlling a drive robot 4, the learning method involving training the operation inference learning model 70 by reinforcement learning in association with the operation inference learning model 70, which infers operations a of a vehicle 2 for making the vehicle 2 run in accordance with a defined command vehicle speed based on a running state s of the vehicle 2 including a vehicle speed, and the drive robot (automatic driving robot) 4, which is installed in the vehicle 2 and which makes the vehicle 2 run based on the operations a. The operation inference learning model 70 is pre-trained by reinforcement learning by outputting a simulated running state o, which is the running state s simulating the vehicle 2 based on the operations a inferred by the operation inference learning model 70, using a vehicle learning model 60, which has been trained by machine learning to simulate actions of the vehicle 2 based on an actual running history of the vehicle 2, and by applying the simulated running state o to the operation inference learning model 70. After the pre-training by reinforcement learning has ended, the operation inference learning model 70 is further trained by reinforcement learning by applying, to the operation inference learning model 70, the running state s acquired by the vehicle 2 being run based on the operations a inferred by the operation inference learning model 70.

There is a possibility that the operation inference learning model 70 that is trained by reinforcement learning will, in the initial stages of reinforcement learning, output undesirable operations a that would be impossible for a human and that will stress an actual vehicle such as, for example, operating a pedal with an extremely high frequency.

According to the features described above, in the initial stages of this reinforcement learning, the vehicle learning model 60 outputs simulated running states o, which are running states s simulating the vehicle 2 based on the operations a inferred by the operation inference learning model 70, and applies these to the operation inference learning model 70 to pre-train the operation inference learning model 70 by reinforcement learning. That is, in the initial stages of reinforcement learning, the operation inference learning model 70 can be trained by reinforcement learning without using the actual vehicle 2. Therefore, stress on the actual vehicle 2 can be reduced.

Additionally, when the pre-training ends, the operation inference learning model 70 is further trained by reinforcement learning by using the actual vehicle 2. Thus, the accuracy by which the operations output by the operation inference learning model 70 are learned can be increased in comparison with the case in which the operation inference learning model 70 is trained by reinforcement learning using only the vehicle learning model 60.

In particular, in the features described above, pre-training is implemented by performing the operations a in the vehicle learning model 60. Thus, the training time can be reduced in comparison with the case in which the operations a are performed in the vehicle 2 in all steps of pre-training.

Additionally, the vehicle learning model 60 is realized by a neural network, and machine learning is implemented by inputting, as learning data, a running history for a prescribed time, by inputting, as teacher data, a running history for a time later than the prescribed time, by outputting the simulated running state for the later time, and by comparing this simulated running state with the teacher data.

Preparing physical models simulating actions for each constituent element in a vehicle and preparing a physical model by combining these as a vehicle model, in the conventional manner, raises development costs. Additionally, in order to prepare a physical model, there is a need to be familiar with the detailed parameters and characteristics of the actual vehicle 2, and if this information cannot be obtained, then the vehicle 2 must be modified or analyzed as needed.

According to the features described above, the vehicle learning model 60 is realized by a neural network. Thus, the vehicle learning model 60 can be realized more easily than in the case of a physical model.

Additionally, the vehicle learning model 60 is used only for pre-training the operation inference learning model 70, and the actual vehicle 2 is used for reinforcement learning after pre-training. That is, the accuracy of the operations a output by the operation inference learning model 70 is raised by reinforcement learning after pre-training, wherein the reinforcement learning uses the actual vehicle 2 to perform the operations a. Thus, the simulation accuracy of the vehicle 2 by the vehicle learning model 60 does not need to be exceedingly high.

Due to the synergistic effect of the above, the entire learning control system 10 can be easily developed.

Additionally, the running states s include, in addition to the vehicle speed, either the accelerator pedal depression level or the brake pedal depression level, or a combination thereof.

Due to the feature described above, the learning control system 10 as described above can be appropriately realized.

The learning system and the learning method for an operation inference learning model for controlling a drive robot according to the present invention is not limited to the above-described embodiments explained by referring to the drawings, and various other modified examples may be contemplated within the technical scope thereof.

For example, in the above-described embodiments, the operation inference learning model 70 is trained by reinforcement learning in which the operations a are performed by the vehicle 2 after the operation inference learning model 70 has been pre-trained by reinforcement learning in which the operations a are performed by the vehicle learning model 60.

After the pre-training, running histories of the vehicle 2 can be further acquired by running the vehicle 2 by operations inferred by the operation inference learning model 70. These newly acquired running histories may be used to further train the vehicle learning model 60 to raise the inference accuracy of the simulated running states, and then the vehicle learning model 60 that has been further trained may be used in addition to the vehicle 2 to perform the inferred operations and to acquire the running states in the reinforcement learning after the pre-training. With such a feature, the time for performing the tests by using the vehicle 2 is reduced. Therefore, the training time of the operation inference learning model 70 can be reduced.

Additionally, in the above-described embodiment, the feature of using the drive robot 4 when collecting actual running history data of the vehicle 2 to be used to train the vehicle learning model 60 was explained. However, in this case, the driver of the vehicle 2 is not limited to being the drive robot 4, and may, for example, be a human. In this case, as already explained regarding the above-described embodiment, for example, a camera or an infrared sensor may be used to measure the operation level of the accelerator pedal 2c and the brake pedal 2d.

Additionally, in the above-described embodiment, the vehicle speed, the accelerator pedal depression level, and the brake pedal depression level were used as the running states, but there is no limitation thereto. For example, the running state may include, in addition to the vehicle speed, any one of the accelerator pedal depression level, the brake pedal depression level, the engine rotation speed, the gear state, and the engine temperature, or a combination thereof.

For example, when the engine rotation speed, the gear state, and the engine temperature are added as running states in addition to the features of the above-described embodiment, the inputs to the vehicle learning model 60 may include, in addition to the vehicle speed series i1, the accelerator pedal series i2, and the brake pedal series i3, an engine rotation speed series, a gear state series, and an engine temperature series for a past time period. Additionally, the output may include, in addition to the estimated vehicle speed series o, an engine rotation speed series, a gear state series, and an engine temperature series for a future time period.

In the case that such a feature is used, a vehicle learning model 60 with higher accuracy can be generated.

Aside from the above, the features in the above-described embodiments may be adopted or rejected and may be changed, as appropriate, to other features as long as they do not depart from the spirit of the present invention.

### REFERENCE SIGNS LIST

1 Testing apparatus
2 Vehicle
3 Chassis dynamometer
4 Drive robot (automatic driving robot)
10 Learning control system (learning system)
11 Learning control apparatus
20 Drive robot control unit
21 Pedal operation pattern generation unit
22 Vehicle operation control unit
23 Drive state acquisition unit
30 Learning unit
31 Command vehicle speed generation unit
32 Inference data shaping unit
33 Learning data shaping unit
34 Learning data generation unit
35 Learning data storage unit
40 Reinforcement learning unit
41 Operation content inference unit
42 State action value inference unit
43 Reward calculation unit
50 Testing apparatus model
51 Drive robot model
52 Vehicle model
53 Chassis dynamometer model
60 Vehicle learning model
70 Operation inference learning model
80 Value inference learning model
i1 Vehicle speed series
i2 Accelerator pedal series
i3 Brake pedal series
a Operation
s Running state
Simulated running state

1. A learning system for an operation inference learning model for controlling an automatic driving robot, the learning system training the operation inference learning model by reinforcement learning, and comprising the operation inference learning model, which infers operations of a vehicle for making the vehicle run in accordance with a defined command vehicle speed based on a running state of the vehicle including a vehicle speed, and the automatic driving robot, which is installed in the vehicle and which makes the vehicle run based on the operations, wherein:
the learning system comprises a vehicle learning model that has been trained by machine learning to simulate actions of the vehicle based on an actual running history of the vehicle, and that outputs a simulated running state, which is the running state simulating the vehicle based on the operations inferred by the operation inference learning model; and
the operation inference learning model is pre-trained by reinforcement learning by applying the simulated running state output by the vehicle learning model to the operation inference learning model, and after the pre-training by reinforcement learning has ended, the operation inference learning model is further trained by reinforcement learning by applying, to the operation inference learning model, the running state acquired by the vehicle being run based on the operations inferred by the operation inference learning model.

2. The learning system for an operation inference learning model for controlling an automatic driving robot according to claim 1, wherein the vehicle learning model is realized by a neural network, and machine learning is implemented by inputting, as learning data, the running state having a prescribed time as a reference point, by inputting, as teacher data, the running history for a time later than the prescribed time, by outputting the simulated running state for the later time, and by comparing this simulated running state with the teacher data.

3. The learning system for an operation inference learning model for controlling an automatic driving robot according to claim 1, wherein the running state includes, in addition to the vehicle speed, any one of an accelerator pedal depression level, a brake pedal depression level, an engine rotation speed, a gear state, and an engine temperature, or a combination thereof.

4. A learning method for an operation inference learning model for controlling an automatic driving robot, the learning method involving training the operation inference learning model by reinforcement learning in association with the operation inference learning model, which infers operations of a vehicle for making the vehicle run in accordance with a defined command vehicle speed based on a running state of the vehicle including a vehicle speed, and the automatic driving robot, which is installed in the vehicle and which makes the vehicle run based on the operations, wherein:
the learning method involves pre-training the operation inference learning model by reinforcement learning by outputting a simulated running state, which is the running state simulating the vehicle based on the operations inferred by the operation inference learning model, using a vehicle learning model, which has been trained by machine learning to simulate actions of the vehicle based on an actual running history of the vehicle, and by applying the simulated running state to the operation inference learning model; and
after the pre-training by reinforcement learning has ended, further training the operation inference learning model by reinforcement learning by applying, to the operation inference learning model, the running state acquired by the vehicle being run based on the operations inferred by the operation inference learning model.
